(19) United States
(12) Patent Application Publication
(10) Pub. No.: US 2006/0279863 A1
(43) Pub. Date: Dec. 14, 2006

(54) Rearview mirror with non-parallel viewing areas

(76) Inventor: Gary T. Starbuck, Eagar, AZ (US)

Correspondence Address: Galasso & Associates, LP, P.O. Box 26503, Austin, TX, 78755-0503, US

(21) Appl. No.: 11/449,993

(22) Filed: Jun. 9, 2006

Related U.S. Application Data
(60) Provisional application No. 60/690,083, filed on Jun. 11, 2005.

(51) Int. Cl. G02B 5/10

(52) U.S. Cl. 359/868; 359/866

(57) ABSTRACT

A rearward viewing mirror attached to a vehicle configured to increase the viewing area generally rearward of the vehicle, in particular, the driver's blind spot. The rearward viewing mirror includes a reflective surface configured to provide an image of objects rearward of the vehicle. The reflective surface further includes a first section and a second section that are configured in a non-parallel manner. An intersecting angle between the first section and the second section is formed within the range of nine to thirteen degrees. The second section is positioned proximate the vehicle such that the rearward viewing mirror provides increased viewing of objects proximate the driver's blind spot while inhibiting distortion thereof.

### PRIORITY UNDER 35 U.S.C. §119(e) & 37 C.F.R. §1.78

This nonprovisional application claims priority based upon the following prior United States provisional patent application entitled: Omni-vision mirror, application No. 60/690,083, files Jun. 11, 2005, in the name of Gary T. Starbuck, which is hereby incorporated by reference for all purposes.

### FIELD OF THE INVENTION

The present invention relates to a rearward vision enhancement apparatus, more specifically but not by way of limitation, a side rearview mirror secured to a vehicle, the mirror being designed to substantially decrease the blind spot of the driver.

### BACKGROUND OF THE INVENTION

Millions of individuals spend time every day driving different types of vehicles to accomplish a multitude of daily tasks. Whether it is an automobile, truck, or motorcycle all of these vehicles are commonly equipped with at least one side rearview mirror to facilitate proper vision behind the vehicle. Proper vision behind the vehicle is important for an operator to safely monitor their surroundings while driving the vehicle.

Typically a conventional vehicle is equipped with an internal rearview mirror and at least one side view mirror that is mounted externally to the vehicle. These mirrors are used in combination to monitor the status of objects and other vehicles that are in a rearward direction of the vehicle. This conventional configuration does provide substantial viewing of objects in a rearward direction of the vehicle with the exception of the driver's blind spot.

Conventional rearview mirror systems are unable to detect objects that are located in the blind spot that is adjacently rearward of each side of the vehicle. Improper vision of this area leads to thousands of vehicle accidents each year. Current devices utilized to enhance a driver's vision of their blind spot create significant distortion of the viewing area. Additionally, these devices increase the driver's ability to properly calculate the depth perception of vehicles or objects located in the driver's blind spot.

A common practice for most drivers is to temporarily rotate their head enough to gain a clear view of their blind spots. This can create a potential safety hazard as the driver temporarily is not focused on the environment immediately in front of the vehicle. Additionally, many drivers with neck or back disabilities cannot successfully maneuver in order to perform an appropriate check for any objects in their blind spot.

Accordingly, there is a need for a device that provides increased vision of objects in the driver's blind spot that does not substantially distort the image of these objects.

### SUMMARY OF THE INVENTION

It is the object of the present invention to provide a side rearview mirror that is mounted to the exterior of a vehicle that substantially increases the driver's ability to view objects in the driver's blind spot.

It is a further object of the present invention to provide a rearview mirror that is mounted to the exterior of a vehicle that utilizes an angular portion to provide substantial viewing of objects in the driver's blind spot.

Another object of the present invention is to provide a rearview mirror having an angular portion that is either an integral portion of the rearview mirror or releasably secured to a portion of a rearview mirror.

A further object of the present invention is to provide a rearview mirror that is mounted to the exterior of a vehicle that substantially increases the vision objects in the driver's blind spot that inhibits distortion of the image of these objects.

To the accomplishment of the above and related objects the present invention may be embodied in the form illustrated in the accompanying drawings. Attention is called to the fact that the drawings are illustrative only. Variations are contemplated as being a part of the present invention, limited only by the scope of the claims.

### BRIEF DESCRIPTION OF THE DRAWINGS

A more complete understanding of the present invention may be had by reference to the following Detailed Description and appended claims when taken in conjunction with the accompanying Drawings wherein:

FIG. 1 is a front view of an embodiment of the present invention;

FIG. 2 is sectional view taken along line A-A of FIG. 1 of an embodiment of the present invention;

FIG. 3 is an end view of an alternative embodiment of the present invention; and

FIG. 4 is a front view of an alternative embodiment of the present invention.

### DETAILED DESCRIPTION

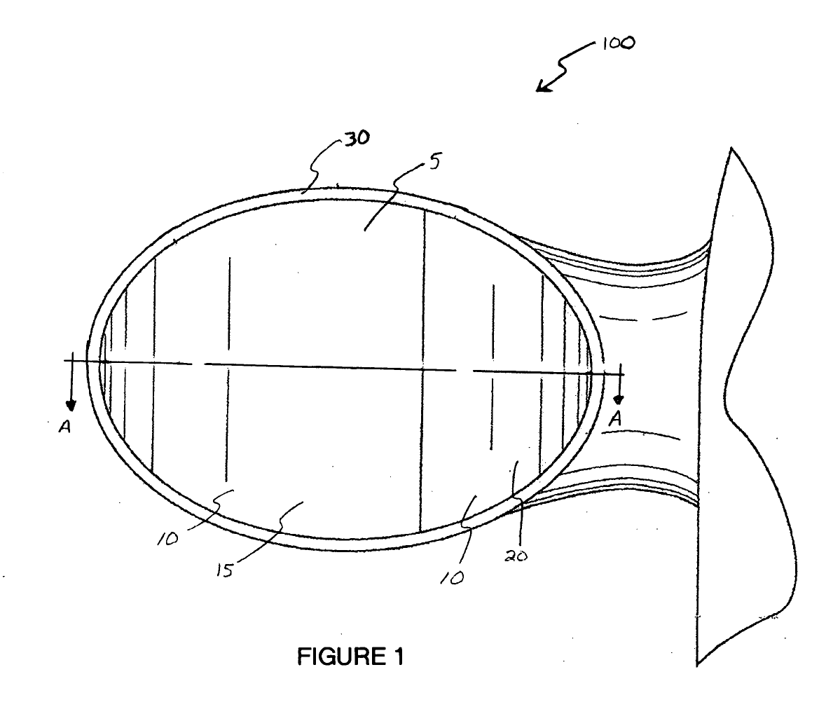

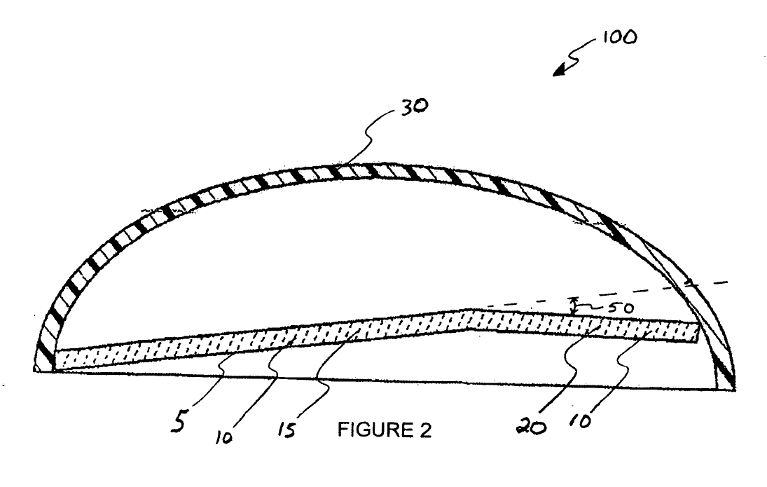

Now referring to the drawings submitted herewith, wherein the various elements depicted therein are not necessarily drawn to scale and wherein like reference numerals are used for like elements throughout the figures and in particular to FIGS. 1 and 2 there is a rearview mirror system 100 constructed according to the principles of the present invention.

The rearview mirror system 100 includes a mirror 10 that comprises a reflective surface 5. The reflective surface 5 is manufactured from conventional materials known in the art that allows viewing of objects generally rearward of a vehicle, with the rearview mirror system 100 being secured to the side of the vehicle.

Mirror 10 includes two sections 15 and 20. Sections 15 and 20 are each configured in a substantially planar manner, and positioned so that section 15 and section 20 are generally configured in a non-parallel planar manner with respect to each other forming an angle 50 there between.

The intersection of sections 15 and 20 of mirror 10 forms angle 50 there between. This angle is optimally configured to allow section 20 to substantially reduce the blind spot of a normal side rearview mirror and to increase the visibility of objects generally rearward of the vehicle.

The general planar orientation of section 20 also inhibits distortion of the objects generally rearward of the vehicle to which the rearview mirror system 100 is secured. While it is contemplated that various angles could be utilized for angle 50, good results have been achieved with angle 50 being approximately 9 degrees. It is further contemplated that the size of section 20 can vary depending on the overall size of rearview mirror system 100, although in a preferred embodiment good results have been achieved with section 20 having a width of approximately two and one-eighth inches.

Mirror 10 is enclosed in a housing 30. The housing is manufactured from a suitable durable and rigid material such as but not limited to plastic or metal. The housing 30 functions to protect the rearview mirror system 100 and provide a method in which to secure the rearview mirror system 100 to the exterior of a motor vehicle. It is contemplated within the scope of the present invention that the rearview mirror system 100 could be secured to numerous different types of vehicles. More specifically but not by way of limitation, the rearview mirror system 100 could be secured to an automobile, truck, motorcycle or watercraft. Furthermore, while the rearview mirror system 100 is illustrated in the drawings submitted herewith as being generally oval in shape, those skilled in the art will recognize that the rearview mirror system 100 could be a plurality of different shapes having two sections that are positioned in a non-parallel and generally planar manner with the second section that is proximate the vehicle to which the rearview mirror system 100 is mounted providing increased visibility of objects located in the conventional blind spot of the driver of the vehicle.

Those skilled in the art will recognize that the rearview mirror system 100 could have additional features as is known in the art and still achieve the desired functionality as described herein. More specifically but not by way of limitation, the rearview mirror system 100 could have anti-fog materials substantially disposed thereon, have a motor electrically coupled thereto to control movement or be heated.

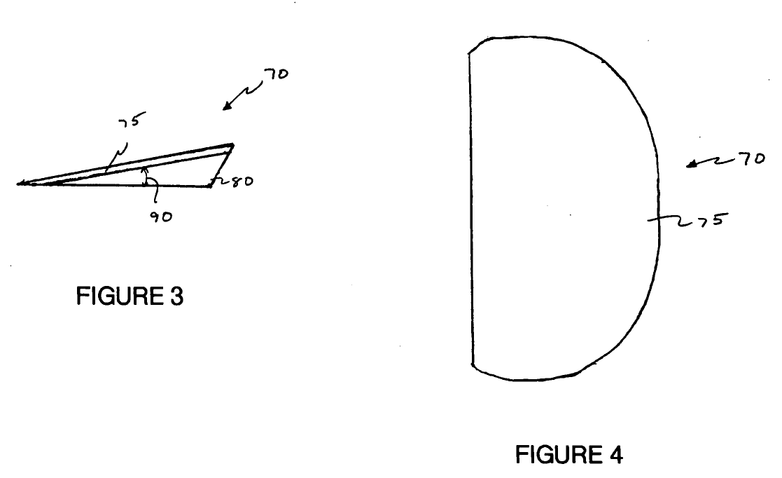

Referring now to FIGS. 3 and 4 there is illustrated an alternative embodiment of the present invention. As described above in reference to FIGS. 1 and 2, section 20 is shown as being contiguous and integrated with section 15. However, it is contemplated to within the scope of the present invention that section 20 could be a separate angled mirror 70 that is attachable to an existing sideview mirror.

As illustrated in FIGS. 3 and 4, angled mirror 70 includes a generally planar mirrored surface 75 disposed on body 80. Body 80 and mirror surface 75 are configured in a wedge shape with an angle 90 to facilitate the operation described herein above of the angle 50 of section 20 of the embodiment of rearview mirror system 100 of FIGS. 1 and 2.

Angled mirror 70 is configured to be secured to a conventional motor vehicle side view mirror by suitable chemical or mechanical methods.

Referring in particular to the drawings submitted herewith, a description of the operation of the rearview mirror system 100 is as follows. If not already attached, a user will mount the rearview mirror system 100 to the desired vehicle or as in the alternative embodiment, secure the angled mirror 70 to an existing external side rearview mirror of a vehicle. The user will then adjust the viewing angle of the rearview mirror system 100 to optimize the rearward view. During operation of the vehicle, the user will periodically glance at the rearview mirror system 100 and observe the objects displayed thereon that are in a generally rearward direction of the vehicle. During this observation period, the second section 20 or angled mirror 70 will provide a substantial view of objects typically not visible to conventional rearview mirrors, objects that are usually located in the driver's blind spot. This process is repeated during operation of the vehicle.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. A reflective device secured to a vehicle comprising:
a reflective surface, said reflective surface being configured to provide an image of objects located generally rearward of the vehicle; and
said reflective surface configured with a first and a second sections, said first and second sections being each configured in a substantially planar manner, with said first and second sections being non-parallel with respect to each other.

2. The reflective device as recited in claim 1, wherein said second section is contiguous with said first section, said first and second sections having an angle therebetween configured to increasing the viewing area of objects rearward of the vehicle.

3. The reflective device as recited in claim 1, wherein said second section is superposed on said first section, said first section and said second section configured to have an angle therebetween that facilitates increased viewing of objects generally rearward of the vehicle.

4. The reflective device as recited in claim 2, wherein said second section is proximate the vehicle.

5. The reflective device as recited in claim 3, wherein said second section is generally wedge shaped and is superposed on said first section proximate the vehicle.

6. The reflective device as recited in claim 5, wherein said angle between said first section and said second section is at an angle between nine to thirteen degrees, inclusive.

7. The reflective device as recited in claim 2, wherein said angle between said first section and said second section is at an angle between nine to thirteen degrees, inclusive.

8. A side rearview mirror system secured to a vehicle comprising:
a mirrored device, said mirrored device having first and second sections, with each of said first and second sections have reflective surface and each being configured in a substantially planar manner; said mirrored device being configured to provide images of objects generally rearward of the vehicle; and
said first and said second sections being configured in a non-parallel manner forming an angle therebetween, said second section for providing an increased visibility of the area generally rearward of the vehicle.

9. The side rearview mirror system as recited in claim 8, wherein said second section is contiguous with said first section, said second section being proximate the vehicle.

10. The side rearview mirror system as recited in claim 8, wherein said second section is releasably secured to said first section proximate the vehicle, said second section being generally wedged shaped.

11. The side rearview mirror system as recited in claim 10, wherein said angle between said first section and said second section being at least in the range of nine to thirteen degrees.

12. The side rearview mirror system as recited in claim 9, wherein said angle between said first section and said second section being at least in the range of nine to thirteen degrees.

13. The side rearview mirror system as recited in claim 12, wherein said second section is approximately two and one-eighth inches in width.

14. The side rearview mirror system as recited in claim 10, wherein said second section is releasably secured to said first section utilizing chemical adhesives.

15. A rearview mirror secured to the exterior of a vehicle configured to provide increased viewing of the area rearward of the vehicle comprising:
a reflective surface, said reflective surface being configured to provide an image of objects rearward of the vehicle; and
said reflective surface including a first section and a second section, said first and said second section being substantially planar, said first and said second section being configured in a non-parallel manner and forming an intersecting angle therebetween, said second section for providing an increased visibility of the area generally rearward of the vehicle.

16. The rearview mirror as recited in claim 15, wherein said second section is releasably secured to said first section.

17. The rearview mirror as recited in claim 15, wherein said second section is contiguous with said first section.

18. The rearview mirror as recited in claim 17, wherein the intersecting angle between said first section and said second section is manufactured to be within the range of approximately nine to thirteen degrees.

19. The rearview mirror as recited in claim 16, wherein the intersecting angle of said second section and said first section is approximately in the range of nine to thirteen degrees.

20. The rearview mirror as recited in claim 19, wherein said second section is approximately two and one-eighth inches in width.
